(19) United States
(12) Patent Application Publication
(10) Pub. No.: US 2002/0052189 A1
(43) Pub. Date: May 2, 2002

(54) Mobile radio communication apparatus

(76) Inventors: Ippo Aoki, Fuchu-shi (JP); Akira Ishikura, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/983,635

(22) Filed: Oct. 25, 2001

(30) Foreign Application Priority Data
Oct. 27, 2000 (JP) 2000-328775

(51) Int. Cl. H04M 11/00

(52) U.S. Cl. 455/404; 455/456; 455/564

(57) ABSTRACT

A mobile radio communication apparatus according to an embodiment of the invention has a memory. The memory stores geographical information items about geographical areas, types of service, and telephone numbers corresponding to the types of service available in each geographical area. When the apparatus is connected to a base station, the geographical information item about the geographical area in which this base station is operating is identified. The user may input service-type information into the apparatus. The service-type information concerns the type of service, which the user wishes to receive. The telephone number which corresponds to the geographical information item identified and the service-type information is retrieved from the memory. The telephone number is transmitted to the base station, whereby the mobile radio communication apparatus can make a call origination to the service center that offer the service the user wants.

### CROSS-REFERENCE TO RELATED APPLICATIONS

This application is based upon and claims the benefit of priority from the prior Japanese Patent Application No. 2000-328775, filed Oct. 27, 2000, the entire contents of which are incorporated herein by reference.

### BACKGROUND OF THE INVENTION

1. Field of the Invention

The present invention relates to a mobile radio communication apparatus that can automatically recognize the telephone number of the service center corresponding to the position of the apparatus.

2. Description of the Related Art

A mobile radio communication system is known, which includes base stations and mobile radio communication apparatuses. The communication apparatuses are to be connected to the base stations over radio channels. Such a mobile radio communication apparatus may be used to make an emergency call to a service center.

It is quite rare for people to make emergency calls to the service centers. Usually, the users of mobile radio communication apparatuses do not remember the telephone numbers of the service centers. In case of emergency, they needs to spend some time to obtain the telephone numbers of the service centers they want to call for help.

Service centers operating in different areas may have different telephone numbers, even if they offer the same service. A user of a mobile radio communication apparatus, who has just moved from an area A to an area B, may dial the telephone number of the service center in the area A, forgetting that the user is now in the area B. That is, the user may dial a wrong number. Besides, the user needs to obtain the telephone number of the service center operating in the area into which the user has just moved from another area.

As described above, the service centers operating in different areas to provide the same service may have different telephone numbers. If the user of a mobile radio communication apparatus does not remember their telephone numbers, the user must obtain the telephone number of the service center that operates in the area the user has just moved into. It usually takes the user some time to get the telephone number.

Further, if the user has forgotten that the user has moved from an area A into an area B, the user may repeatedly input the telephone number of the service center operating in the area A (i.e., the wrong number), to call the service center operating in the area B.

### BRIEF SUMMARY OF THE INVENTION

Accordingly, an object of the present invention is to provide a mobile radio communication apparatus that can dial the number of a service center operating in one area when the user operates the apparatus in a simple way, even if the user does not perceive that the user has moved into the area from another where a service center having a different telephone number operates to provide the same service.

To achieve the object, the present invention provides various mobile radio communication apparatuses.

A mobile radio communication apparatus according to a first aspect of the invention can be connected by radio channels to one of base stations operating in a plurality of geographical areas. The apparatus comprises:

a memory configured to store geographical information, types of service provided in the geographical areas and telephone numbers assigned to the types of service provided in each geographical area;

an identifying section configured to identify geographical information concerning the geographical area in which the base station connected to the apparatus exists;

an input section configured to input service-type information concerning the type of service which the user of the apparatus wishes to receive; and

a controller configured to retrieve and transmit the stored telephone number corresponding to the stored geographical information and the stored service-type information which coincides with the identified geographical information and the input service-type information.

A mobile radio communication apparatus according to a second aspect of the invention can be connected by radio channels to one of base stations operating in a plurality of geographical areas. The apparatus comprises:

a memory configured to store geographical information, types of service provided in the geographical areas and telephone numbers assigned to the types of service provided in each geographical area;

a receiving section configured to receive a signal from one of the base stations so as to set the apparatus to be an idle state;

an identifying section configured to identify geographical information concerning the geographical area in which the base station connected to the apparatus exists based on the received signal;

an input section configured to input service-type information concerning the type of service which the user of the apparatus wishes to receive; and

a controller configured to retrieve and transmit the stored telephone number corresponding to the stored geographical information and the stored service-type information which coincides with the identified geographical information and the input service-type information.

A mobile radio communication apparatus according to a third aspect of the invention can be connected by radio channels to one of base stations operating in a plurality of geographical areas. The apparatus comprises:

a first memory configured to store geographical information, types of service provided in the geographical areas and telephone numbers assigned to the types of service provided in each geographical area;

a receiving section configured to receive a signal including a system ID from one of the base stations so as to set the apparatus to be an idle state;

a second memory configured to store geographical information and a system ID corresponding to the geographical information;

an identifying section configured to identify geographical information concerning the geographical area in which the base station connected to the apparatus exists, the identified geographical information corresponding to the stored system ID which coincides with the received system ID;

an input section configured to input service-type information concerning the type of service which the user of the apparatus wishes to receive; and

a controller configured to retrieve and transmit the stored telephone number corresponding to the stored geographical information and the stored service-type information which coincides with the identified geographical information and the input service-type information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a mobile radio communication apparatus according to the first embodiment of the present invention;

FIG. 2 is a diagram illustrating a mobile communication system incorporating the first and second embodiment of the invention, in which base stations cover geographic service areas that overlap one another;

FIG. 3 is a flowchart explaining how the apparatus of FIG. 1 seizes the most appropriate base station in the communication system of FIG. 2 and then is set in an idle state, or how the apparatus displays a message informing the user that there is no base station than to which the apparatus can be connected;

FIG. 4 represents an acquisition table stored in the memory shown in FIG. 1, the table showing frequency bands, communication types and channel numbers, in association with acquisition indices;

FIG. 5 illustrates a system table stored in the memory shown in FIG. 1, the table showing system ID numbers of base stations, priority data items and acquisition indices, in association with geographic service areas (GEOs);

FIG. 6 shows a PRN table stored in the memory shown in FIG. 1, the PRN showing system ID numbers of base stations, priority data items and acquisition indices, in association with geographic service areas (GEOs);

FIG. 7 is a flowchart illustrating the control process performed when the apparatus remaining in an idle state receives a user's demand for a call origination to a specific telephone number; and

FIG. 8 is a diagram for explaining an operation is made on the menu displayed on the screen in order to make the call origination shown in FIG. 7.

### DETAILED DESCRIPTION OF THE INVENTION

### First Embodiment

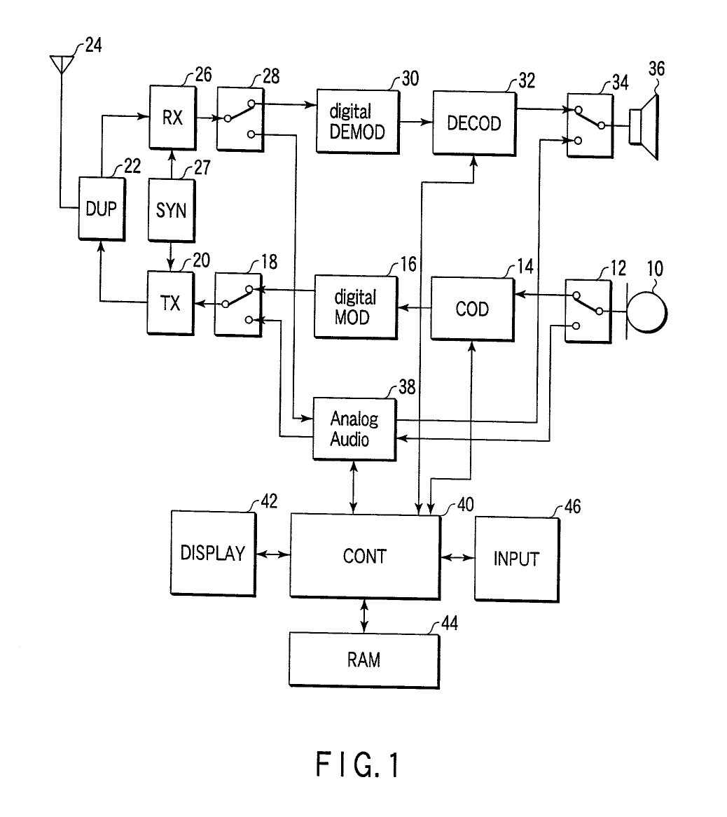

The first embodiment of the present invention will be described. FIG. 1 is a block diagram showing a mobile radio communication apparatus according to the first embodiment. The apparatus can be connected by radio to a base station (not shown). As shown in FIG. 1, the apparatus comprises a microphone 10, a switch 12, an encoder 14, a digital modulator 16, a switch 18, a radio transmitter 20, a duplexer 22, and an antenna 24, a radio receiver 26, and a synthesizer 27, a switch 28, a digital demodulator 30, a decoder 32, a switch 34, and a loudspeaker 36.

As FIG. 1 shows, an audio signal from the microphone 10 is supplied via the switch 12 to the encoder 14. The encoder 14 converts the audio signal to a digital signal and compresses the digital signal to be supplied to the digital modulator 16. The digital modulator 16 modulates the compressed digital signal. The modulated digital signal is supplied via the switch 18 to the radio transmitter 20. The radio transmitter 20 converts the modulated digital signal to a high-frequency signal in accordance with a local signal output from the synthesizer 27. The high-frequency signal is amplified to a prescribed power level. The signal thus amplified is supplied to the duplexer 22 and thence to the antenna 24 only. The antenna 24 transmits the amplified signal, which is a high-frequency radio signal.

The antenna 24 may receive a high-frequency radio signal transmitted from a base station. The high-frequency radio signal is supplied to the duplexer 22 and then to the radio receiver 26 only. The radio receiver 26 amplifies the received signal and converts the amplified received signal to a baseband (low-frequency) signal in accordance with a local signal supplied from the synthesizer 27. The baseband signal is supplied via the switch 28 to the digital demodulator 30. The digital demodulator 30 performs digital demodulation on the baseband signal.

The demodulated signal output from the digital demodulator 30 is supplied to the decoder 32. The decoder 32 decompresses the baseband signal and converts the decompressed signal to an analog signal. The analog signal is input, through the switch 34, to the loudspeaker 36. The loudspeaker 36 generates speech sound from the analog signal.

All signal-processing steps described above are carried out when the radio communication is implemented in digital mode. How signals are processed when the radio communication is performed in analog mode will be described below.

As FIG. 1 shows, the mobile radio communication apparatus further comprises an analog audio circuit 38, a controller 40, a display 42, a memory (RAM) 44, and an input operation unit 46. In the analog communication mode, the movable contact in the switches 12, 18, 28 and 34 is switched from the upper stationary contact to the lower stationary contact, in accordance with instructions given by the controller 40. Now that the movable contact is connected to the lower stationary contact in the switches 12, 18, 28 and 34, the analog signal output from the microphone 10 is input via the switch 12 to the analog audio circuit 38. The analog audio circuit 38 modulates the analog signal. The modulated signal is supplied via the switch 18 to the radio transmitter 20. The radio transmitter 20 converts the analog modulated signal to a high-frequency signal. The high-frequency signal is supplied via the duplexer 22 to the antenna 24. The antenna 24 transmits the high-frequency signal.

In the analog communication mode, a radio signal transmitted from a base station is supplied from the antenna 24 via the duplexer 22 to the radio receiver 26. The radio receiver 26 converts the received radio signal, to a baseband signal. The baseband signal is supplied to the analog audio circuit 38. The circuit 38 demodulates the baseband signal to an analog demodulated signal, which is output via the switch 34 to the loudspeaker 36. The loudspeaker 36 generates speech sound from the analog demodulated signal.

The display 42, RAM 44 and input operation unit 46 are connected to the controller 40. To perform telecommunication, the user may operate the unit 46, thus inputting data. The display 42 displays the data thus input. Alternatively, the user may use the display 42 and the input operation unit 46 to input character data when the user utilizes the short-message service (SMS).

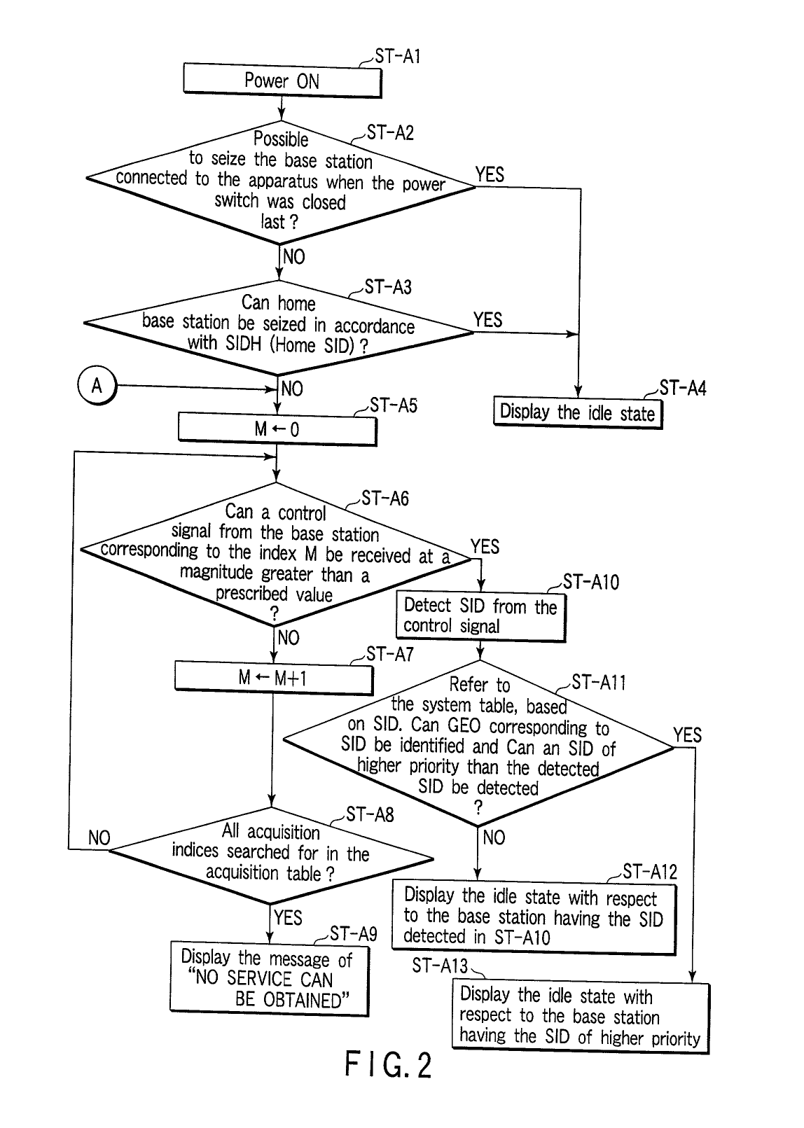

As shown in FIG. 2, the mobile radio communication system comprises four base stations A1, A2, A3 and B included in a geographical area (GEO). A systems ID number (SID) is assigned to each base station, each identifying one base station. The four service areas overlap one another as illustrated in FIG. 2. More specifically, SID189 is assigned to the base station A1. Suppose the user of the apparatus has entered a contract with this base station A1. Then, the base station A1 is the home base station to the mobile radio communication apparatus. Note that SID85, SID121 and SID44 are assigned to the base stations A2, A3 and B, respectively.

How the controller 40 operates to bring the apparatus into the idle state will be described, thereby to explain how the mobile radio communication apparatus seizes a base station.

The RAM 44 stores the ID number (SID) and frequency (f) assigned to the base station to which the apparatus was connected when the power switch on the apparatus was closed last. The RAM 44 stores GEO that represents the geographical area in which the base station was operating when the apparatus was turned off last. The GEO is data that is identified in order to detect the SID. How the GEO is identified will be described later. The SID of the base station the apparatus seized last, the frequency allocated to the base station, and the GEO are stored into the MRU (Most Recently Used) region of the RAM 44.

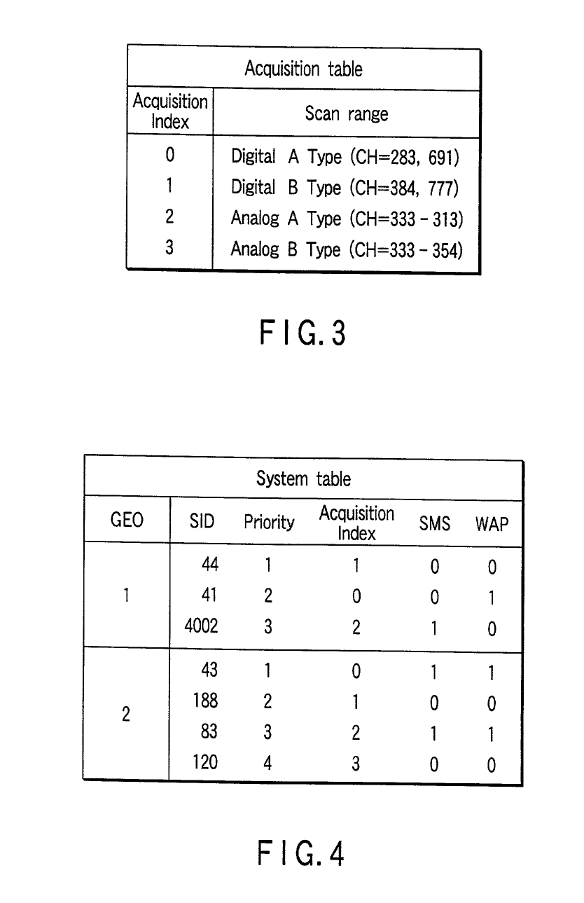

In Step ST-A1 shown in FIG. 3, the mobile radio communication apparatus is turned on. The apparatus tries to seize the base station to which the apparatus was connected when the apparatus was turned off last, in accordance with the SID of the base station and the frequency f assigned to the base station (Step ST-A2). The apparatus can seize the base station if the signal of a specific frequency that the apparatus receives has a magnitude equal to or greater than a predetermined value and if the SID of the base station is detected. If the apparatus seizes in Step ST-A2 the base station to which the apparatus was connected when it was turned off last, the apparatus is set in an idle state (Step ST-A11).

If the apparatus fails to seize the last seized base station, the operation proceeds to Step ST-A3. Step ST-A3 and the following steps are a control process that enables the mobile radio communication apparatus to seize the base station more appropriate for the apparatus than any other base stations.

In Steps ST-A3 and ST-A4, the mobile radio communication apparatus tries to seize one base station after another, in the increasing order of acquisition indices shown in the acquisition table of FIG. 4. Each acquisition index contains the channel number CH representing the frequency f that should be searched for.

Most of mobile radio communication systems installed in the United States are dual systems. In a dual system, a digital system and an analog system are simultaneously in service, so that a mobile radio communication apparatus can be connected to one of the digital system and the analog system. Digital systems are classified into two types, for example. The first type is known as “digital A type”, and the second type as “digital B type”. Similarly, analog systems are classified into two types, i.e., “analog A type” and “analog B type”. In the present embodiment of the invention, four different types of systems can exist in a same geographical area. As indicated above, each base station belongs to a system of one of these four types.

The acquisition indices are associated with priority data items of the above-mentioned four types of the systems. The higher the priority a base station has, the lower the charge at which the base station offers service. Hence, the apparatus tries to seize base stations in the order of the acquisition indices.

In Step ST-A3, the apparatus sets the acquisition index at, for example, “0”. Then, in Step ST-A4, the apparatus first tries to seize the base station that belongs to the acquisition index 0, i.e., the base station of the digital A type. To allow the apparatus to seize such a base station, the controller 40 sets the receiving frequency for the channel CH283, in accordance with the local signal from the synthesizer 27. The controller 40 then tries to receive a control signal transmitted from the base station over the channel CH283. The controller 40 may fail to receive the control signal having a magnitude (an electric field intensity) equal to or greater than the prescribed value. If so, the controller 40 sets the receiving frequency for the channel CH691 and tries to receive a control signal from the base station over the channel CH691.

If the controller 40 fails to receive the control signal transmitted over the channel CH691, the acquisition index M is increased by one in Step ST-A12. Thus, the index M changes to “1”, i.e., the base station of the digital B type. Then the controller 40 tries to receive a control signal transmitted from the base station over the channel CH384, if the controller 40 fails to receive the control signal transmitted over the channel CH384, and then a control signal transmitted from the base station over the channel CH777.

In Step ST-A13, the controller 40 determines whether all acquisition indices have been searched for in the acquisition table. If the controller 40 receives no control signals of the frequencies that correspond to the acquisition indices described in the acquisition table, the control process proceeds to Step ST-A14. In Step ST-A14, the display 42 displays the message of “NO SERVICE CAN BE OBTAINED”, for example.

The controller 40 may seize a control signal having the frequency that corresponds to the acquisition index M (M is any integer ranging from 0 to 3 in the case of the acquisition table shown in FIG. 4). In this case, the control process proceeds to Step ST-A5. It the SID contained in the control signal is detected in Step ST-A5, the control process proceeds to Step ST-A6. In Step ST-A6, the system table stored in the RAM 44 is referred to, as will be described below.

In the mobile communication system, particularly in the United States, providers are often merged into a big company or purchase other providers to grow. Consequently, the charging system of the same provider may vary in different geographical areas. Thus, in any area other than the area for which the user has entered a contract with a provider, the types of base stations may not always assume the same priority order as indicated by the acquisition indices shown in the acquisition table of FIG. 4. If the mobile radio communication apparatus seizes base stations in accordance with the acquisition table only, the apparatus may be connected to a base station that offers service at relatively high charges in an area other than the contracted area.

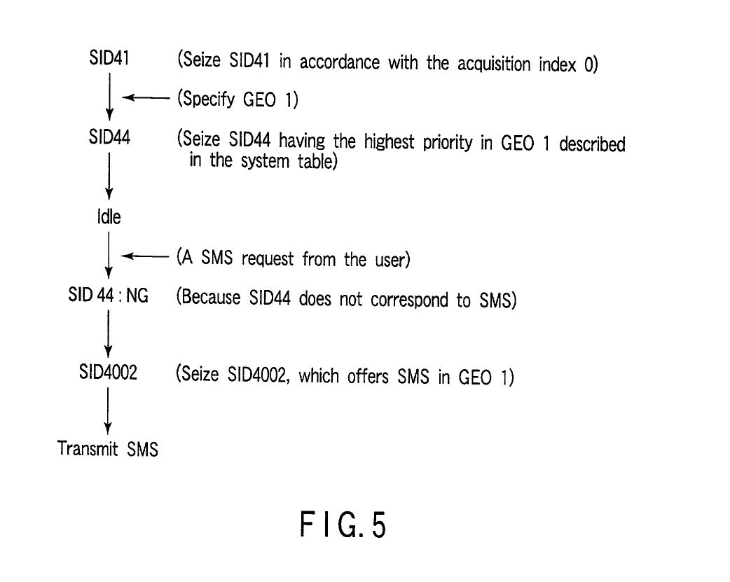

To solve the deficiency, a system table of the type shown in FIG. 4 has been prepared for two or more geographical areas (GEOs), so that the mobile radio communication apparatus may be connected to a base station that offers service at the lowest charge in each geographical area. The system table of FIG. 5 is applied to the present embodiment.

As seen from FIG. 5, the system table shows GEOs, the SIDs of the base stations operating in the GEOs, the priorities assigned to the base stations, and the acquisition indices of the base stations.

Referring back to the flowchart of FIG. 3, the apparatus may seize, in Step ST-A5, the base station identified by the acquisition index M described in the acquisition table. If so, the control process goes to Step ST-A6, in which the SID of the base station seized is detected from the control signal. Then, the control process proceeds to Step ST-A7. In Step ST-A7, the system table of FIG. 5 is referred to, thereby to identify the GEO that has the SID identical to the SID detected.

If the GEO containing the SID detected is identified, the control process proceeds to Step ST-A8. In Step ST-A8, it is determined whether an SID can be detected, which pertains to the GEO detected and which has higher priority than the SID detected in Step ST-AS.

In the first embodiment, the acquisition indices stored correspond to SIDs, in one-to-one relation. The frequency data equivalent to each acquisition index is therefore identified with reference to the acquisition table. From the frequency data it is determined whether the controller 40 has received a control signal transmitted from a base station. If it is determined that the controller 40 has received a control signal, it is then determined whether the SID contained in the control signal is identical to the SID of the above-mentioned base station of high priority, so that the apparatus may seize the base station of high priority. It is then determined whether an SID has been detected, which has higher priority than that having the SID detected in Step ST-AS (Step ST-A8). If such an SID has been detected, the display 42 displays the idle state with respect to the base station having the SID of higher priority (Step ST-A9). If the apparatus fails to seize the base station of the highest priority described in the system table, it will try to seize the base station of the second highest priority.

The mobile radio communication apparatus may fail to seize no base stations in Step ST-A8. No area (GEO) having the SID identical to the SID detected in Step ST-A5 may be identified in ST-A7. In either case, the control process proceeds to Step ST-A10. In Step ST-A10, the SID detected in Step ST-A5 is seized, and the display 42 displays the idle state with respect to the base station having the SID detected in Step ST-A5.

The priority order of the base stations operating in the geographical area into which the mobile radio communication apparatus has moved may differ from the priority order described in the acquisition table. The apparatus can, nonetheless, seize the base station of the highest priority, with reference to the system table.

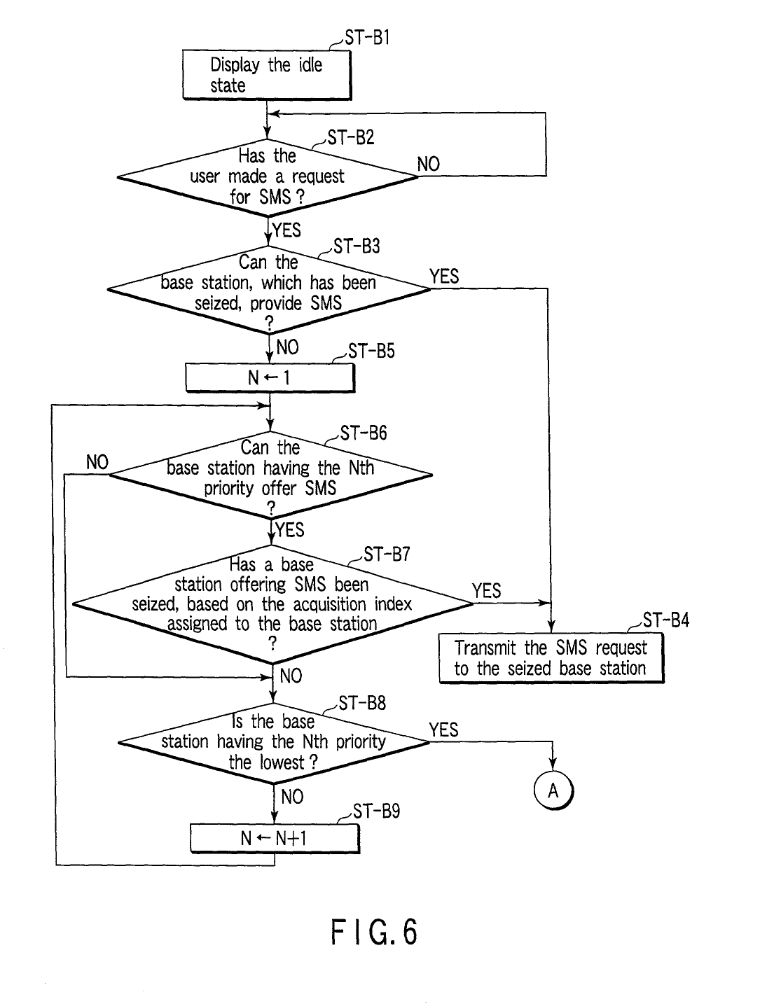

The RAM 44 may store a PRN table, which is shown in FIG. 6. The PRN table shows the numbers assigned to GEOs, the service numbers corresponding to the GEOs, and the PRN indices corresponding to the GEO. Three PRN indices are recorded for one GEO. PRN index 1 is an emergency number; PRN index 2 is the number of an automobile support center (AAA); PRN index 3 is the number of the support center of the provider. In most cases, the telephone numbers of the same services in different GEOs are different.

For example, the emergency number is “911” for GEO 1, “*911” for GEO 2, and “#911” for GEO 3. That is, even if the provided service is same, different GEOs are assigned to different numbers of the service, respectively.

The RAM 44 stores different numbers that are assigned to different GEOs and PRN indices, respectively. Therefore, the mobile radio communication apparatus can always select the appropriate telephone number corresponding to the desired service for the user, even if the user does not perceive that the user has moved into the GEO from another. Nor will the user likely to input a wrong telephone number.

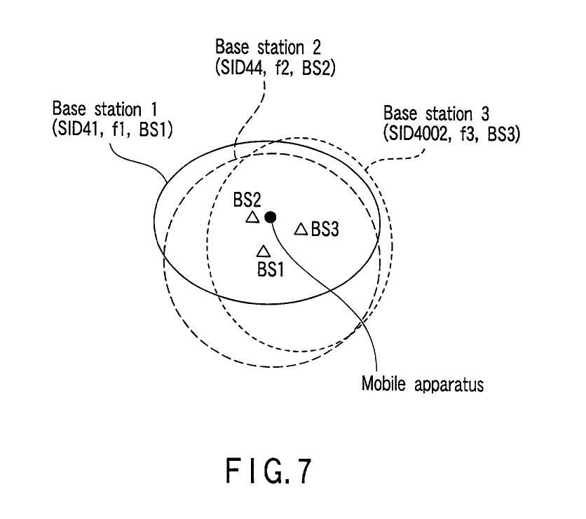

The control process that is performed when the apparatus remaining in the idle state (Steps ST-11, ST-A9 and ST-A10, FIG. 3) receives a user's demand for a call origination to a specific telephone number will be described, with reference to FIG. 7.

The user selects “call”, thus making a call origination demand, in accordance with the menu displayed by the display 42 (LCD), and inputs the PRN index that corresponds to the service the user wants (Step ST-B1).

More precisely, if the user selects “call” in the LCD-displayed menu, the display 42 displays an image, requesting that the user should select any one of three service. The user may select the service and then may operate the call key. In this case, the PRN table of FIG. 6 is referred to, thus retrieving the telephone number of the service that operates in the area (GEO) in which the mobile radio communication apparatus is located. The call is made to the telephone number thus retrieved.

In Step ST-B1 shown in FIG. 7, the user inputs the PRN index and pushes the call button, thereby making a call origination demand. Then, in Step ST-B2, the PRN table is referred to, in accordance with the GEO determined in the idle state and the PRN index input by the user. As a result, the telephone number that corresponds to the PRN index and the GEO is retrieved.

The mobile radio communication apparatus now held by the user makes a call origination to the base station by the telephone number retrieved (Step ST-B3). The apparatus is then connected to the service center having the number retrieved, whereby the user can talk with the person at the telephone (Step ST-B4). The display 42 (LCD) may display the telephone number retrieved, and the user may dial the number displayed to talk with the person at the telephone of this number.

### Second Embodiment

In the first embodiment, the PRN index that corresponds to the number of the service center to which a call origination should be made is specified in accordance with a menu displayed by the display 42. Nonetheless, the PRN index may be specified in a different way in the present invention.

In the second embodiment of the invention, telephone numbers are assigned to the numeral keys. More specifically, the number of an emergency center is assigned to the “1” key, the number of an automobile support center (AAA) to the “2” key, and the number of a provider to the “3” key. When the user keeps pushing any one of these numeral keys for some time, the telephone number is retrieved and a call origination is made to the service center of the number retrieved, as in the first embodiment.

Therefore, the user need not select a telephone number in accordance with a menu displayed, in order to make a call origination to the service center of this number. Even if the user wishes to call an emergency number, the user only needs to perform a one-touch operation. This enables the user to make a call within a short time.

The first and second embodiments are designed for use in a dual system, in which a digital system and an analog system are simultaneously in service. The mobile radio communication apparatus according to the invention can be connected to either the analog system or the digital system. Nonetheless, the use of the embodiments of the invention is not limited to such a dual system. Rather, the embodiments may be used in a dual system comprising two digital systems or two analog systems. Moreover, the use of the invention is not limited to dual systems. That is, the mobile radio communication apparatus according to the invention may be one that can be connected to only an analog system or a digital system. Thus, the present invention can be applied to a mobile radio communication apparatus for use in any type of a mobile radio communication system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio communication apparatus to be connected over radio channels to one of base stations operating in a plurality of geographical areas, the apparatus comprising:
a memory configured to store geographical information, types of service provided in the geographical areas and telephone numbers assigned to the types of service provided in each geographical area;
an identifying section configured to identify geographical information concerning the geographical area in which the base station connected to the apparatus exists;
an input section configured to input service-type information concerning the type of service which the user of the apparatus wishes to receive; and
a controller configured to retrieve and transmit the stored telephone number corresponding to the stored geographical information and the stored service-type information which coincides with the identified geographical information and the input service-type information.

2. The apparatus according to claim 1, wherein the service-type information is input when the user keeps pushing a numeral key longer than a predetermined time.

3. The apparatus according to claim 1, wherein the telephone numbers assigned to the types of service provided in each geographical area are emergency call numbers.

4. The apparatus according to claim 1, wherein the identifying section identifies the geographical information before the apparatus is set in an idle state, and the input section inputs the service-type information after the apparatus is set in the idle state.

5. A mobile radio communication apparatus to be connected over radio channels to one of base stations operating in a plurality of geographical areas, the apparatus comprising:
a memory configured to store geographical information, types of service provided in the geographical areas and telephone numbers assigned to the types of service provided in each geographical area;
a receiving section configured to receive a signal from one of the base stations so as to set the apparatus to be an idle state;
an identifying section configured to identify geographical information concerning the geographical area in which the base station connected to the apparatus exists based on the received signal;
an input section configured to input service-type information concerning the type of service which the user of the apparatus wishes to receive; and
a controller configured to retrieve and transmit the stored telephone number corresponding to the stored geographical information and the stored service-type information which coincides with the identified geographical information and the input service-type information.

6. The apparatus according to claim 5, wherein the service-type information is input when the user keeps pushing a numeral key longer than a predetermined time.

7. The apparatus according to claim 5, wherein the telephone numbers assigned to the types of service provided in each geographical area are emergency call numbers.

8. A mobile radio communication apparatus to be connected over radio channels to one of base stations operating in a plurality of geographical areas, the apparatus comprising:
a first memory configured to store geographical information, types of service provided in the geographical areas and telephone numbers assigned to the types of service provided in each geographical area;
a receiving section configured to receive a signal including a system ID from one of the base stations so as to set the apparatus to be an idle state;
a second memory configured to store geographical information and a system ID corresponding to the geographical information;
an identifying section configured to identify geographical information concerning the geographical area in which the base station connected to the apparatus exists, the identified geographical information corresponding to the stored system ID which coincides with the received system ID;
an input section configured to input service-type information concerning the type of service which the user of the apparatus wishes to receive; and
a controller configured to retrieve and transmit the stored telephone number corresponding to the stored geographical information and the stored service-type information which coincides with the identified geographical information and the input service-type information.

9. The apparatus according to claim 8, wherein the service-type information is input when the user keeps pushing a numeral key longer than a predetermined time.

10. The apparatus according to claim 8, wherein the telephone numbers assigned to the types of service provided in each geographical area are emergency call numbers.
